(19) United States
(12) Patent Application Publication
(10) Pub. No.: US 2017/0262472 A1
(43) Pub. Date: Sep. 14, 2017

(54) SYSTEMS AND METHODS FOR RECOGNITION OF FACES E.G. FROM MOBILE-DEVICE-GENERATED IMAGES OF FACES

(71) Applicant: ISITYOU LTD., Lod (IL)

(72) Inventor: Shmuel GOLDENBERG, Ness Tziona (IL)

(21) Appl. No.: 15/529,272

(22) PCT Filed: Nov. 24, 2015
(86) PCT No.: PCT/IL2015/051134

§ 371 Date: May 24, 2017

Related U.S. Application Data
(60) Provisional application No. 62/083,324, filed on Nov. 24, 2014.

(51) Int. Cl. G06F 17/30; H04W 88/02; G06Q 20/38; G06K 9/00; H04N 1/00

(52) U.S. Cl. CPC G06F 17/30247; G06K 9/00221; G06K 9/00295; H04N 1/00177; G06Q 20/382; H04W 88/02; H04N 2201/0096

(57) ABSTRACT

A method for recognizing faces including providing image/s in which a face is to be recognized; using a processor for constructing biometric feature set/s, including a statistical distribution thereof, from a multiplicity of N facial images (samples); generating template/s, using a processor, from a multiplicity of M facial images which is at least partly disjoint to the N facial images; computing scores, using a processor, to quantify an extent to which at least some of the templates match one another, pairwise; and testing whether an enroll image and a test image match by using plural feature extraction technologies to generate plural respective templates for the enroll image and for the test image and comparing therebetween thereby to generate score/s indicating an extent to which the enroll and test images match.

### REFERENCE TO CO-PENDING APPLICATIONS

Priority is claimed from U.S. provisional application No. 62/083,324, filed 24 Nov. 2014 and entitled “FACIAL RECOGNITION IN A MOBILE DEVICE”.

### FIELD OF THIS DISCLOSURE

The present invention relates generally to user authentication and more particularly to user authentication for device, application, and account access and authorization of mobile payments and other sensitive communications.

### BACKGROUND FOR THIS DISCLOSURE

Published US patent applications US2011/0312376 and US2011/0098024 describe conventional facial recognition.

Certain state of the art facial recognition technology and face data sets are described at a Justin Lee article, dated 19 Mar. 2015, posted at the following www link: biometricupdate.com/201503/google-claims-its-facial-recognition-system-can-achieve-near-100-percent-accuracy. However, the article refers to the LFW database which includes images taken in ideal illumination and Photo-shopped images, rather than to mobile applications.

Uncountable numbers of operations have gone mobile, such as, but not limited to, mobile payments accepted by online banks and payment processors, as well as telecommunication, travel, insurance and gaming enterprises.

FConventional facial recognition solutions aimed to authorize mobile device users' access from an initial lock screen, experience problems in accommodating for extreme lighting conditions.

Mobile based face-based unlock solution suffers from a frustratingly high rate of false negatives.

IsItYou's website, including the company's presentation at TechCrunch Disrupt 2014 in San Francisco, demonstrates how IsItYou's technology compares favorably with state of the art technologies.

The disclosures of all publications and patent documents mentioned in the specification, and of the publications and patent documents cited therein directly or indirectly, are hereby incorporated by reference.

### SUMMARY OF CERTAIN EMBODIMENTS

Certain embodiments of the present invention seek to provide a system for recognition of faces e.g. in images which may be self-generated, using unsupervised mobile devices, in diverse environments e.g. in the wild. The term “mobile (communication) device” as used herein is intended to include but not be limited to any of the following: mobile telephone, smart phone, playstation, ipad, TV, remote desktop computer, game console, tablet, mobile e.g. laptop or other computer terminal, embedded remote unit.

Certain embodiments seek to secure smartphone and mobile services. It is appreciated that in the mobile world, no ability to control for imaging device, pose, lighting, attitude, or location (e.g. background surrounding the face) can be assumed; it is not possible to determine how high the device's camera will be, nor to add illumination. Illumination for example may vary from bright sunlight to complete darkness, e.g. dark room where the sole illumination is from the mobile device itself; also, illumination may be chaotic and may differ to any unknown degree, on different parts of the user's face. Occlusion of the face, e.g. due to sunglasses or a beard or the end-user's hands, is also possible.

Certain embodiments seek to provide facial recognition resulting in 2 or 3 out of 100, out of 1000, out of 10,000 or even only one in 100,000 or more incorrect matches from among a total number of images matched. It is advantageous to provide a rate low enough to facilitate end user interactions with financial institutions including face-based authentication for payments; in contrast to conventional mobile devices, in which facial recognition may fail 2 or 3 times out of ten.

Certain embodiments seek to provide a face recognition program operating on a mobile device.

Certain embodiments seek to provide a first system for facial recognition; the system comprising:
a. at least one data base of facial images;
b. a first module; first module is adapted to detect first visual data transferred through lens of the first module;
c. a computer readable medium (CRM) in communication with the first module and at least one data base; the CRM having at least one first instruction, and at least one second instruction thereon; wherein the first instruction is for (i) registration of the first visual data on the CRM; (ii) determination of luminosity profile of the first visual data; and (iii) creation of a second visual data by performing global histogram equalization on the first visual data;
the second instruction is for face recognition of the first visual data including at least three operations of: (a) face detection in the second visual data; (b) extraction of features of the face; and (iii) search for match of the face with the facial images stored in at least one data base.

According to certain embodiments, plural transformations (e.g. DCT, Gabor (say) for magnitude features, LBP (say) for texture) are employed to extract a feature set/feature vector, which may for example include magnitude and/or text features, from an image, The vector may be projected onto a low-dimensional subspace to reduce the vector's dimensionality. A suitable technique such as WPCA, LDA, and/or PLDA may be employed to generate a representation which facilitates match/reject decisions.

According to certain embodiments, feature extraction operations are applied in parallel to both an original gray-scale image and a photo-normalized gray-scale image, which may result in plural, say, 6 parallel processes.

It is an object of certain embodiments to disclose the first system as defined above, wherein the CRM reside in a device selected from a group consisting of: mobile device, tablet, laptop, and any other electronic device.

It is an object of certain embodiments to disclose the first system as defined above, wherein the device is operated upon successful match of the face with the facial images stored in at least one data base.

It is an object of certain embodiments to disclose the first system as defined above, wherein the device is locked upon failure of match of the face with the facial images stored in at least one data base.

It is an object of certain embodiments to disclose the first system as defined above, wherein the CRM additionally comprises at least one third instruction for registration of users.

It is an object of certain embodiments to disclose the first system as defined above, wherein the device additionally comprises an accelerometer.

It is an object of certain embodiments to disclose the first system as defined above, wherein the accelerometer is adapted to detect pulse of a living creature.

It is an object of certain embodiments to disclose the first system as defined above, wherein at least part of the data base is located on a computer selected from a group consisting of: the CRM, cloud, central server, and a combination thereof.

It is an object of certain embodiments to disclose the first system as defined above, wherein first match according to n parameters is performed between the face and at least part of the data base located on the CRM; and second match according to m parameters is performed between the face and at least part of the data base located on the cloud; n is an integer larger than zero; m is an integer larger than zero.

It is an object of certain embodiments to disclose the first system as defined above, wherein the second instruction is for comparing first match according to n parameters and second match according to m parameters.

It is an object of certain embodiments to disclose the first system as defined above, wherein the second instruction includes recognition of time dependent facial features associated with facial pulsatile flow of ramifications of the carotid artery of a living person in the first visual data.

It is an object of certain embodiments to disclose the first system as defined above, wherein the first instruction and the second instruction are executed in parallel to the CRM operation.

It is one object of the present invention to disclose a first method for facial recognition; the method comprising
a. capturing first visual data by means of a camera;
b. connecting between the camera and a computer readable medium (CRM) having instructions thereon,
c. transforming the first visual data into second visual data via the instructions;
d. providing at least one data base of facial images;
e. recognizing a face in the second visual data via instructions by: (i) detecting a face in the second visual data; (ii) extracting features of the face; and (iii) searching for match of the face with the facial images stored in at least one data base;
wherein the first transforming comprises (i) determining luminosity profile of the first visual data; (ii) creating second visual data by performing global histogram equalization on the first visual data.

It is an object of certain embodiments to disclose the first method as defined above, wherein the CRM reside in a device selected from a group consisting of: mobile device, tablet, laptop, and any other electronic device.

It is an object of certain embodiments to disclose the first method as defined above, additionally comprising activating the device upon successful matching of the face with the facial images stored in at least one data base.

It is an object of certain embodiments to disclose the first method as defined above, additionally comprising de-activating the device upon failing to match the face with the facial images stored in at least one data base.

It is an object of certain embodiments to disclose the first method as defined above, additionally comprising registering users in the CRM via instructions.

It is an object of certain embodiments to disclose the first method as defined above, additionally comprising providing an accelerometer.

It is an object of certain embodiments to disclose the first method as defined above, additionally comprising adapting the accelerometer to detect pulse of a living creature.

It is an object of certain embodiments to disclose the first method as defined above, additionally comprising setting at least part of the data base on a computer selected from a group consisting of: the CRM, cloud, central server, and a combination thereof.

It is an object of certain embodiments to disclose the first method as defined above, additionally comprising (i) performing first matching according to n parameters between the face and at least part of the data base located on the CRM; and (ii) performing second matching according to m parameters between the face and at least part of the data base located on the cloud; n is an integer larger than zero; m is an integer larger than zero.

It is an object of certain embodiments to disclose the first method as defined above, additionally comprising comparing first match according to n parameters and second match according to m parameters.

It is an object of certain embodiments to disclose the first method as defined above, additionally comprising recognizing of time dependent facial features associated with facial pulsatile flow of ramifications of the carotid artery of a living person in the first visual data.

It is an object of certain embodiments to disclose the first method as defined above, additionally comprising executing the instructions in parallel to the CRM operation.

It is one object of the present invention to disclose a second system for facial recognition; the system comprising:
a. at least one first data base of first facial images templates stored in a central server;
b. a first module; the first module is adapted to detect visual data transferred through lens of the first module;
c. a computer readable medium (CRM) in communication with (i) the first module; and (ii) the at least one first data base; the CRM having instructions thereon for facial recognition of the visual data; and
d. at least one second data base of second facial images templates stored on the CRM;
wherein the instruction for facial recognition includes (i) first match between the facial picture and at least one of the second facial images templates; (ii) second match between the facial picture and at least one of the first facial images templates; and (iii) compare between the first match and the second match.

It is an object of certain embodiments to disclose the second system as defined above, wherein the facial recognition includes a preliminary manipulation on the first visual data.

It is an object of certain embodiments to disclose the second system as defined above, wherein the manipulation includes: (i) determination of luminosity profile of the visual data; and (ii) creation of a modified visual data by performing global histogram equalization on the visual data

It is an object of certain embodiments to disclose the second system as defined above, wherein the CRM resides in a device selected from a group consisting of: mobile device, tablet, laptop, and any other electronic device.

It is an object of certain embodiments to disclose the second system as defined above, wherein the device is operated upon successful match of the face with the facial images stored in at least one data base.

It is an object of certain embodiments to disclose the second system as defined above, wherein the device is locked upon failure of match of the face with the facial images stored in at least one data base.

It is an object of certain embodiments to disclose the second system as defined above, wherein the CRM is adapted to execute registration of users via the instructions.

It is an object of certain embodiments to disclose the second system as defined above, wherein the device additionally comprises an accelerometer.

It is an object of certain embodiments to disclose the second system as defined above, wherein the accelerometer is adapted to detect a pulse of a living creature.

It is an object of certain embodiments to disclose the second system as defined above, wherein the instructions include recognition of time dependent facial features associated with facial pulsatile flow of ramifications of the carotid artery of a living person in the visual data.

It is an object of certain embodiments to disclose the second system as defined above, wherein the instructions are executed in parallel to the CRM operation.

It is one object of the present invention to disclose a second method for facial recognition; the method comprising:
a. providing (i) at least one first data base of first facial images templates stored in a central server; (ii) a first module; adapting the first module to detect visual data transferred through lens of the first module;
b. communicating between a computer readable medium (CRM) with (i) the first module; and (ii) at least one first data base; the CRM having instructions thereon for facial recognition of the visual data; and
c. providing at least one second data base of second facial images templates stored on the CRM;
wherein said method includes the following operations performed by instructions for facial recognition of:
d. first matching between the facial picture and at least one of the second facial images templates;
e. second matching between the facial picture and at least one of the first facial images templates; and
f. comparing between the first match and the second match.

It is an object of certain embodiments to disclose the second method as defined above, additionally comprising preliminary manipulating the first visual data before the facial recognition.

It is an object of certain embodiments to disclose the second method as defined above, wherein the manipulation includes: (i) determining luminosity profile of the visual data; and (ii) creating a modified visual data by performing global histogram equalization on the visual data.

It is an object of certain embodiments to disclose the second method as defined above, additionally comprising placing the CRM in a device selected from a group consisting of: mobile device, tablet, laptop, and any other electronic device.

It is an object of certain embodiments to disclose the second method as defined above, additionally comprising activating the device upon successful matching of the face with the facial images stored in at least one data base.

It is an object of certain embodiments to disclose the second method as defined above, additionally comprising de-activating the device upon failure of match of the face with the facial images stored in at least one data base.

It is an object of certain embodiments to disclose the second method as defined above, additionally comprising registrating users via the instructions.

It is an object of certain embodiments to disclose the second method as defined above, additionally comprising providing the device an accelerometer.

It is an object of certain embodiments to disclose the second method as defined above, additionally comprising detecting pulse of a living creature by the accelerometer.

It is an object of certain embodiments to disclose the second method as defined above, additionally comprising recognizing of time dependent facial features associated with facial pulsatile flow of ramifications of the carotid artery of a living person in the visual data.

It is an object of certain embodiments to disclose the second method as defined above, additionally comprising executing the instructions in parallel to the CRM operation.

It is an object of the present invention to disclose a first mobile device adapted for detection of human face; the mobile device comprising:
a. a camera adapted to detect visual data, and
b. a computer readable medium (CRM) having instructions thereon for facial recognition;
wherein the instructions include recognition of time dependent facial features associated with facial pulsatile flow of ramifications of the carotid artery of a living person in the facial image.

It is an object of certain embodiments to disclose the first mobile device as defined above, wherein the mobile device is activated upon the recognition.

It is an object of certain embodiments to disclose the first mobile device as defined above, wherein the mobile device is de-activated upon failure of the recognition.

It is an object of certain embodiments to disclose the first mobile device as defined above, wherein the facial recognition includes a preliminary manipulation on the first visual data.

It is an object of certain embodiments to disclose the first mobile device as defined above, wherein the manipulation includes: (i) determination of luminosity profile of the visual data; and (ii) creation of a modified visual data by performing global histogram equalization on the visual data.

It is an object of the present invention to disclose a third method for detecting human face comprising:
a. providing a mobile device comprising (i) a camera for detecting visual data; and (ii) a computer readable medium (CRM) having instructions thereon for facial recognition;
wherein the method additionally comprises:
b. recognizing via the instructions time dependent facial features associated with facial pulsatile flow of ramifications of the carotid artery of a living person in the facial image.

It is an object of certain embodiments to disclose the third method as defined above, additionally comprising activating the mobile device upon the recognition.

It is an object of certain embodiments to disclose the third method as defined above, additionally comprising de-activating the mobile device upon failure of the recognition.

It is an object of certain embodiments to disclose the third method as defined above, additionally comprising preliminary manipulating the visual data.

It is an object of certain embodiments to disclose the third method as defined above, wherein the manipulation includes: (i) determination of luminosity profile of the visual data; and (ii) creation of a modified visual data by performing global histogram equalization on the visual data.

It is an object of certain embodiments to disclose a second mobile device adapted for detection of human face; the mobile device comprising:
a. a camera adapted to capture visual data;
b. a data base of facial videos templates; and
c. a computer readable medium (CRM) having instructions thereon for facial recognition;
wherein the instructions include detection of aliasing frequencies in the facial images templates resulting from phase mismatch between (i) the visual data; and (ii) the facial videos templates.

It is an object of certain embodiments to disclose the second mobile device as defined above, wherein the mobile device is activated upon the detection.

It is an object of certain embodiments to disclose the second mobile device as defined above, wherein the mobile device is de-activated upon failure of the detection.

It is an object of certain embodiments to disclose the second mobile device as defined above, wherein the facial recognition includes a preliminary manipulation on the first visual data.

It is an object of certain embodiments to disclose the second mobile device as defined above, wherein the manipulation includes: (i) determination of luminosity profile of the visual data; and (ii) creation of a modified visual data by performing global histogram equalization on the visual data.

It is an object of certain embodiments to disclose a fourth method for detecting human face comprising:
a. providing a mobile device comprising (i) a camera for detecting visual data; (ii) a data base of facial videos templates; and (iii) a computer readable medium (CRM) having instructions thereon for facial recognition,
wherein the method additionally comprises:
b. detecting via the instructions aliasing frequencies in the facial images templates resulting from phase mismatch between (i) the visual data; and (ii) the facial videos templates.

It is an object of certain embodiments to disclose the fourth method as defined above, additionally comprising activating the mobile device upon the detection.

It is an object of certain embodiments to disclose the fourth method as defined above, additionally comprising de-activating the mobile device upon failure of the detection.

It is an object of certain embodiments to disclose the fourth method as defined above, additionally comprising preliminary manipulating the visual data.

It is an object of certain embodiments to disclose the fourth method as defined above, wherein the manipulation includes: (i) determination of luminosity profile of the visual data; and (ii) creation of a modified visual data by performing global histogram equalization on the visual data.

In some embodiments of the current invention, the CRM is in a device selected from a group consisting of: mobile device, tablet, laptop, and any other electronic device.

In some embodiments of the current invention, the successful recognition of a face may result in activating the device, or, in the case of failure of face recognition, locking the device. This may also apply to some programs of the device which is activated only upon recognizing of a specific face (and vice versa by limiting access upon unsuccessful recognition). This activating/deactivating may be of the first match, the second match, or the final compare between the two.

It may be possible, in some embodiments, to register users to the device (and to the application performing the recognition). This may be done by the instruction on the CRM.

In some embodiments of the current invention, the device does not capture a photo of the face in front of the lens, but detects it without performing any action (other than operating the camera).

In some embodiments of the current invention, the face recognition or the manipulation prior to the face recognition is done in parallel to the CRM operation. That is, other applications may run on the device while the face recognition is operated.

In some embodiments of the current invention, activating the mobile device occurs upon recognition.

In some embodiments of the current invention, de-activating the mobile device occurs upon failure of the recognition.

In some embodiments of the current invention, manipulation includes: (i) determination of luminosity profile of the visual data and (ii) creation of a modified visual data by performing global histogram equalization on the visual data.

One embodiment includes a mobile device adapted for detection of human face; the mobile device comprising:
a. a camera adapted to capture visual data;
b. a data base of facial videos templates; and
c. a computer readable medium (CRM) having instructions thereon for facial recognition;
wherein the instructions include detection of aliasing frequencies in the facial images templates resulting from phase mismatch between (i) the visual data; and (ii) the facial videos templates.
Use of the above may include detecting, via the instructions, aliasing frequencies in the facial image templates resulting from phase mismatch between (i) the visual data; and (ii) the facial videos templates.

At least the following embodiments are provided:

### Embodiment 1

A method for recognizing faces including:

providing at least one image in which a face is to be recognized;

using a processor for constructing at least one biometric feature set, including a statistical distribution thereof, from a multiplicity of N facial images (samples);

generating at least one template, using a processor, from a multiplicity of M facial images which is at least partly disjoint to the multiplicity of N facial images;

computing scores, using a processor, to quantify an extent to which at least some of the templates match one another, pairwise; and

testing whether an enroll image and a test image match by using plural feature extraction technologies to generate plural respective templates for the enroll image and plural respective templates for the test image and comparing the plural templates for the enroll image to the plural templates for the test image thereby to generate at least one score indicating an extent to which the enroll and test images match.

### Embodiment 2

A method according to any of the preceding embodiments wherein WPCA is used to construct at least one biometric feature set from the multiplicity of N facial images.

### Embodiment 3

A method according to any of the preceding embodiments wherein LDA is used to construct at least one biometric feature set from the multiplicity of N facial images.

### Embodiment 4

A method according to any of the preceding embodiments wherein PLDA is used to construct at least one biometric feature set from the multiplicity of N facial images.

### Embodiment 5

A method according to any of the preceding embodiments wherein at least one biometric feature set is constructed from a multiplicity of N gray-scale registered images each generated from a raw color image.

### Embodiment 6

A method according to any of the preceding embodiments wherein at least one biometric feature set is constructed from a multiplicity of N registered photo-normalized images each generated from a raw color image.

### Embodiment 7

A face recognition system including:

a repository including at least one biometric feature set, including a statistical distribution thereof, constructed from a multiplicity of N facial images (samples); and

a processor configured for generating at least one template from a multiplicity of M facial images which is at least partly disjoint to the multiplicity of N facial images, computing scores to quantify an extent to which at least some of the templates match one another, pairwise; and testing whether an enroll image and a test image match by using plural feature extraction technologies to generate plural respective templates for the enroll image and plural respective templates for the test image and comparing the plural templates for the enroll image to the plural templates for the test image thereby to generate at least one score indicating an extent to which the enroll and test images match.

### Embodiment 8

A method according to any of the preceding embodiments wherein the raw color image is imaged by a mobile device camera.

### Embodiment 9

A method according to any of the preceding embodiments wherein the at least one biometric feature set comprises first and second biometric feature sets respectively constructed from a first multiplicity of N gray-scale registered images and a second multiplicity of N registered photo-normalized images and wherein corresponding pairs of first and second images, from among the first and second multiplicities respectively, are both generated from the same raw color image in a data repository including N raw color images.

### Embodiment 10

A method according to any of the preceding embodiments wherein WPCA is used to generate at least one template from the multiplicity of M facial images.

### Embodiment 11

A method according to any of the preceding embodiments wherein LDA is used to generate at least one template from the multiplicity of M facial images.

### Embodiment 12

A method according to any of the preceding embodiments wherein PLDA is used to generate at least one template from the multiplicity of M facial images.

### Embodiment 13

A method according to any of the preceding embodiments wherein at least one biometric feature set is generated from a multiplicity of M grayscale registered images each generated from a raw color image.

### Embodiment 14

A method according to any of the preceding embodiments wherein at least one biometric feature set is generated from a multiplicity of M registered photo-normalized images each generated from a raw color image.

### Embodiment 15

A method according to any of the preceding embodiments wherein the raw color image is imaged by a mobile device camera.

### Embodiment 16

A method according to any of the preceding embodiments wherein the at least one biometric feature set comprises first and second biometric feature sets respectively constructed from a first multiplicity of M gray-scale registered images and a second multiplicity of M registered photo-normalized images and wherein corresponding pairs of first and second images, from among the first and second multiplicities respectively, are both generated from the same raw color image in a data repository including M raw color images.

### Embodiment 17

A method according to any of the preceding embodiments wherein the computing of scores employs cosine-based scoring.

### Embodiment 18

A method according to any of the preceding embodiments wherein the templates include templates derived using plural feature extraction technologies and wherein the computing scores comprises fusing scores quantifying an extent to which templates derived using a first feature extraction technology match pairwise with scores quantifying an extent to which templates derived using at least a second feature extraction technology match pairwise.

### Embodiment 19

A method according to any of the preceding embodiments wherein the templates include templates derived from grayscale registered images and templates derived from registered photo-normalized images and wherein the computing scores comprises fusing scores quantifying an extent to which templates derived from gray-scale registered images match pairwise with scores quantifying an extent to which templates derived from registered photo-normalized images match pairwise.

### Embodiment 20

A method according to any of the preceding embodiments wherein the plural feature extraction technologies include at least one of: Gabor, LBP, DCT.

### Embodiment 21

A method according to any of the preceding embodiments wherein the fusing comprises computing a linear combination of scores.

### Embodiment 22

A method according to any of the preceding embodiments wherein the fusing comprises LLR fusion.

### Embodiment 23

A method according to any of the preceding embodiments wherein the testing includes generating gray-scale registered and registered photo-normalized images from a full color raw enroll image, generating gray-scale registered and registered photo-normalized images from a full color raw test image, and applying plural feature extraction technologies to the gray-scale registered and registered photo-normalized images generated from the full color raw enroll image and also to the gray-scale registered and registered photo-normalized images generated from the full color raw test image.

### Embodiment 24

A method according to any of the preceding embodiments and also comprising thresholding the score using at least first and second thresholds and determining whether the enroll and test images do or do not match, if the score outlies the first and second thresholds respectively and performing at least one additional identity verification process if the score lies between the first and second thresholds.

### Embodiment 25

A computer program product, comprising a non-transitory tangible computer readable medium having computer readable program code embodied therein, the computer readable program code adapted to be executed to implement a method for recognizing faces including:

providing at least one image in which a face is to be recognized;

constructing at least one biometric feature set, including a statistical distribution thereof, from a multiplicity of N facial images (samples);

generating at least one template from a multiplicity of M facial images which is at least partly disjoint to the multiplicity of N facial images;

computing scores to quantify an extent to which at least some of the templates match one another, pairwise; and

testing whether an enroll image and a test image match by using plural feature extraction technologies to generate plural respective templates for the enroll image and plural respective templates for the test image and comparing the plural templates for the enroll image to the plural templates for the test image thereby to generate at least one score indicating an extent to which the enroll and test images match.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”. “computing”, “estimating”, “selecting”, “ranking”, “grading”, “calculating”, “determining”, “generating”. “reassessing”, “classifying”, “generating”. “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

FIGS. 1-12 are simplified flowchart illustrations of a face recognition method according to certain embodiments; each method typically comprises some or all of the illustrated operations, suitably ordered e.g. in the order illustrated.

FIG. 13 illustrates a flow for preprocessing of an image prior to face detection according to certain embodiments.

FIG. 14 is a simplified block diagram a face recognition system according to certain embodiments.

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

A face recognition system (engine/s) for recognizing faces in images captured by mobile communication devices is described herein in detail. The system may comprise some or all of the following software modules: face detection module, feature extraction module, feature fusion module and matching module e.g. as shown in the block diagram of FIG. 14. These may operate in conjunction with one or more servers/processors and associated data repositories, and suitable imaging apparatus such as mobile device cameras held by end users, e.g. as described herein. It is appreciated of course that plural cooperating face recognition engines may be provided which may be networked or co-located.

The input to the face recognition system typically comprises a color digital image acquired by a device camera. Typically, there is no restriction on image size which may be, but is not necessarily, VGA or QVGA. Typically, there is no restriction on image format which may be, but is not necessarily, jpeg, png, tiff. The first module in the face recognition system typically comprises a real-time face detection module which may be based on the Viola-Jones object detector, e.g. as implemented in OpenCV. The face detection module is used to detect a face (e.g. distinguish faces from non-faces) in the acquired image, e.g. locate the face, if any, in the image, and typically crop accordingly.

Typically, the trained data included some light tilted pose variation, e.g. up to +(−) 15 degrees, to facilitate detection of slightly tilted faces.

More generally, any suitable face detection module may be employed, which may perform some or all of the following stages, suitably ordered e.g. as follows: Feature Selection e.g. Haar feature selection; creating an Integral Image; training e.g. Adaboost Training; and cascading classifiers.

Typically, if multiple faces are detected by the face detection module 20, the face with the largest size is selected, using conventional image processing e.g. for identifying the largest rectangle from among rectangles surrounding or circumscribing the respective face regions. According to certain embodiments, if a low light environment is detected by face detection module 20 and if no face is detected, a suitable low light compensation algorithm (e.g. adaptive histogram equalization followed by Gaussian smoothing to flatten noise) is employed by the face detection module 20 to facilitate detecting the face, if any.

The facial image yielded by face detector 20 next undergoes “registration”.

Within the detected face, a suitable tool e.g. application, again, of the Viola-Jones object detector is used for eye detection. Alternatively any suitable eye detector tool may be employed to find eye coordinates; it is appreciated that object detectors such as Viola-Jones typically comprise a trainable machine; face data or eye data may be used thereby to form a specific face-detection or eye-detection model respectively.

Once eye coordinates are found by the eye detector, the facial image undergoes “registration” e.g. geometric normalization, after which the face is said to be “registered and normalized”. Typically, registration includes face rotation for plane rotated faces, so that the registered face is aligned to the reference X-axis. Typically, the face is cropped according to the left (say) eye coordinates, le(x,y), using crop parameters, aka distance parameters, pl, pu, pr and pd, typically comprising predetermined percentages of the face's ocular distance which is abs(re(x,y)−le(x,y)).

Typically, then, the face is cropped to the left by a distance le(x,y)−pl, upward by a distance le(x,y)−pu, to the right by a distance abs(re(x,y)−le(x,y))+pr and downward by a distance le(x,y)+pd,

Suitable values may be selected, conventionally, to yield suitable face scales.

The final color face image is also rescaled to a uniform size e.g. 100×100 pixels.

The color registered face image is next converted into a gray-scale image following a photo-normalization procedure using any conventional contrast stretching or histogram stretching or dynamic range expansion technique particularly if certain or many of the faces are believed to suffer from uneven or low illumination.

A feature extraction module 30 typically utilizes 3 separate processes (Gabor feature extraction, Local Binary Pattern (LBP) feature extraction, and Discrete Cosine Transform (DCT) feature extraction) for extracting facial features from the grayscale normalized face image and/or from the registered face image.

Typically, the feature extraction module 30 operates on both of: the original gray-scale image and the photo-normalized images of the face.

If Gabor feature extraction is used, the gray-scale face image typically undergoes a convolution process with a set of Gabor bank filters which may have 8 spatial orientations and 5 frequency scales in which case the convolution process output includes 40 complex results. The Gabor features are then constructed by taking the magnitude of the Gabor convolution process. Finally, the resulting data is down-sampled, e.g. to 16×16 pixels, in which case the output comprises a first 10240-dimensional Gabor based vector.

The same procedure is applied to the photo-normalized image, thereby yielding a second 10240-dimensional (say) Gabor based vector.

If LPB feature extraction is used, a (second e.g.) set of vectors may be generated by computing LBP histograms locally, on 8×8 window size scanning the whole image. It is known in the art that LBP image descriptors transform an image into an array or image of integer labels describing the small-scale appearance of the image. This array or image of integer labels may be represented by suitable image statistics such as a histogram.

An LPB image descriptor is typically applied to the gray-scale face image and also to the photo-normalized image, on both image representations.

If DCT feature extraction is used, a conventional cosine transformation may be run, on the pixel level, for each of the 2 images (the gray-scale face (first) image and the photo-normalized (second) image). The DCT transforms the pixel space into a frequency domain The output, for each image typically comprises an ordered frequency coefficient matrix having the same dimension (say m×n) as the original (1^{st} or 2^{nd}) image which is scanned lexicographically e.g. from left to right and from top to bottom. Each row of the scanned matrix is concatenated into a single column-wise vector of dimension [mn]×1, whose components are then sorted in descending (say) order of their coefficient values.

The resulting vector is then cropped to obtain a shorter vector including only the L (e.g. 960) first i.e. largest elements.

The output of the feature extraction module 30 for each face-containing image, is termed herein the “compact biometric feature data set” of each image and typically totals 2 Gabor based vectors, 2 LBP histograms, and 2 shortened column vectors, also termed herein “the 6 (2×3) trained biometric features” or “the 6 feature vectors” or “the 6 transformation data elements” (assuming that the 2 above-described image representations and the 3 above-described image descriptors are all used).

A system training procedure is typically performed during set up, in which suitable transformation matrices are typically computed, including the following 6 matrices:
PCA, LDA and PLDA transformation matrices to be used for Gabor features extracted from the original gray-scale image.
PCA, LDA and PLDA transformation matrices to be used for Gabor features extracted from the photometrically normalized gray-scale image.
PCA, LDA and PLDA transformation matrices to be used for LBP features extracted from the original gray-scale image.
PCA, LDA and PLDA transformation matrices to be used for LBP features extracted from the photometrically normalized gray-scale image.
LDA and PLDA transformation matrices to be used for pixel-intensity features of the original gray-scale image.
LDA and PLDA transformation matrices to be used for pixel-intensity features of the photometrically normalized gray-scale image.

The training procedure typically trains on annotated training data (e.g., facial imagery); the annotation typically comprises an indication associating certain images since all of these images are shots of a single person.

Typically, the data repository which serves as input to the training stage includes as many images as possible of each human subject. Typically, some or all human subjects are imaged under different conditions such as different illumination conditions (bright/dark/uneven), and with/without various occluding accessories, such as glasses or a hat.

The face recognition system is typically model based; the encoded statistics represented by the 6 transformation data may be extracted using a large set of facial imagery which may include tens of thousands of sample images of human subjects. At least 3 samples are typically provided per human subject. Large numbers of distinctive classes of unique identities (humans) may be harvested from multiple public databases such as Facebook or proprietary data repositories. To ensure that the face recognition system, once trained, can cope with a large degree of environmental variability, the imagery (training) set includes facial images acquired in a variety of real life environmental conditions including various illumination conditions, various partial occlusions, also termed herein “occlusions”, such as but not limited to hat, glasses, scarf, beard, fingers, or poses which deviate slightly from the frontal pose.

To ensure that the process is computationally tractable, the PCA (Principal Component Analysis)-based whitening transform (WPCA) may be used, as is conventional, to reduce data dimensionality. WPCA may also be employed as is conventional, to de-correlate data as much as possible, so that redundant information is removed while valuable and distinctive information is kept.

To reduce the memory footprint, WPCA may be applied only to the first 2 transformations (to the Gabor and LBP transformations and not to the cosine transformation. The WPCA operation is followed by (a) a linear discriminant analysis (LDA) projection operation, followed by computation of PLDA (Probabilistic Linear Discriminant Analysis) feature vectors for each of the two image descriptors employed in the LBP transformation. The LDA typically minimizes the class-within scatter matrix and maximizes the class-between scatter matrixes.

As described above, the compact “biometric feature data set” of each image typically comprises statistics yielded by 6 separate transformations which may be regarded as 6 respective “biometric models”.

A “matching attempt” refers to an evaluation of a target sample including determining whether the target sample is genuine or impostor, relative to a given query sample (previously imaged human subject), the target and query samples are suitably compared; for example, some or all of the following operations may be performed:
a. each facial target image sample may first undergo face detection, pre-processing and feature extraction as above which may yield 6 trained biometric features. projection into a corresponding model may yield a single target template.
b. The same procedure is applied to the query sample, yielding a single query template.
c. Conventional cosine-based scoring may be computed between the two biometric templates generated in operations a, b above.
d. Operations a, b, c may be repeated e.g. 5 more times, if 6 different scores are to be provided e.g. assuming that the 2 above-described image representations are crossed with the 3 above-described image descriptors.
e. All 6 (say) scores are combined e.g. using a linear-logistic-regression-based (LLR) fusion technique, thereby to generate a final score for a given matching attempt. The fusion technique provides 6 different weights corresponding to the model contribution which are used to compute a single overall score.

If the result of the above evaluation or comparison yields similarity, this indicates that the target sample is a “genuine” representation of the face in the “query sample”. If the result of the above evaluation or comparison indicates a lack of similarity between the target and query samples, this indicates that the target sample is not a genuine representation of the face in the “query sample”; instead, the human whose face is represented in the target sample may be regarded as an “impostor”.

When matching, the face recognition system employs an enroll data set including a multiplicity of images in which each of a corresponding multiplicity of registered users, typically identified respectively by unique identifiers e.g. names or ID numbers, has captured her or his facial biometrics. His facial image typically undergoes face detection pre-processing and feature extraction, as described above.

A similar enroll (gallery) biometric template may be generated by “projecting” the enroll biometric data features into the trained models by multiplying the matrix from the biometric template with the matrix corresponding to the trained model.

To control unknown users' access to a system a test biometric template (aka “compact biometric feature data set”) may be computed for an unknown user and matched versus all 100,000 (say) gallery (enroll) biometric templates.

A false acceptance threshold (FAT) and a similarity threshold (ST) may be predetermined e.g. using a conventional receiver operating characteristic curve, which may be derived from a suitable “development/test” set of images. When the matching score is below FAT, access may be denied. When the computed score is above ST, access to the unknown user may be granted. If the score value is between FAT and ST, a learning operation may be performed, e.g. by asking the user to provide his credentials.

For example, in an enrollment phase, each user may be shown a pictogram including a predefined set of images and may select a few of these images, thereby to define for himself a “graphic password” comprising a selected set of, or sequence of, predetermined images. If this is the case, then if a user's score is between FAT and ST, the user is asked to present additional validation e.g. his graphic password. If the graphic password (say) supplied by the unknown user is correct, the unknown user is assumed to be genuine. The application typically has a bypass procedure in case the user is manually deemed genuine, although his score is under FAT.

Typically, the above operations are performed by an application (cell app) downloaded onto a user's mobile device. Typically, the app does not store any graphical depiction of the user's face and instead may store only the template e.g. compact biometric feature data set for that user's face such that each user's privacy is protected since his facial identity is stored only in encoded form.

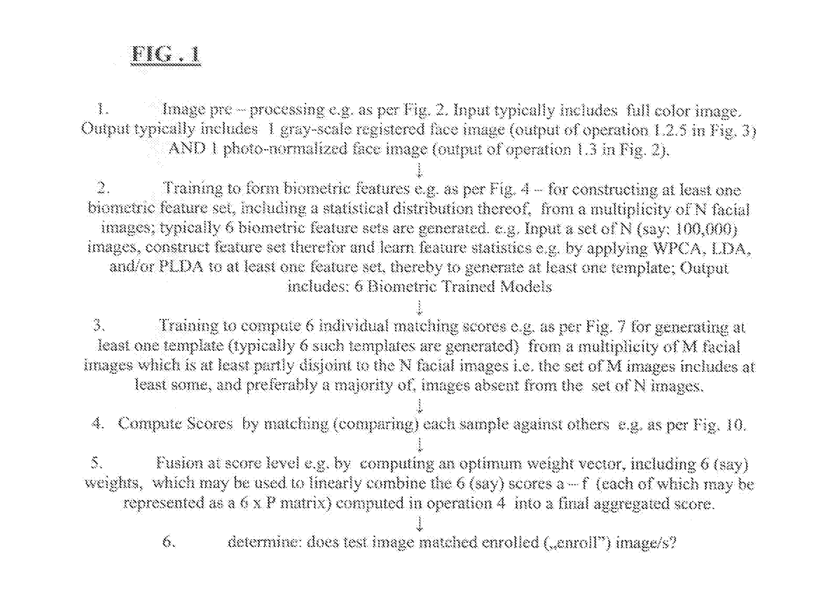

An example facial recognition method for recognizing faces e.g. in images imaged by mobile device cameras is now described in detail with reference to FIGS. 1-12; it is appreciated that any suitable subset of the operations illustrated may be provided and the operations may be performed in any suitable order such as but not limited to the order shown.

The method of FIG. 1 typically includes some or all of the following operations, which may be performed in any suitable order such as but not limited to the following order:

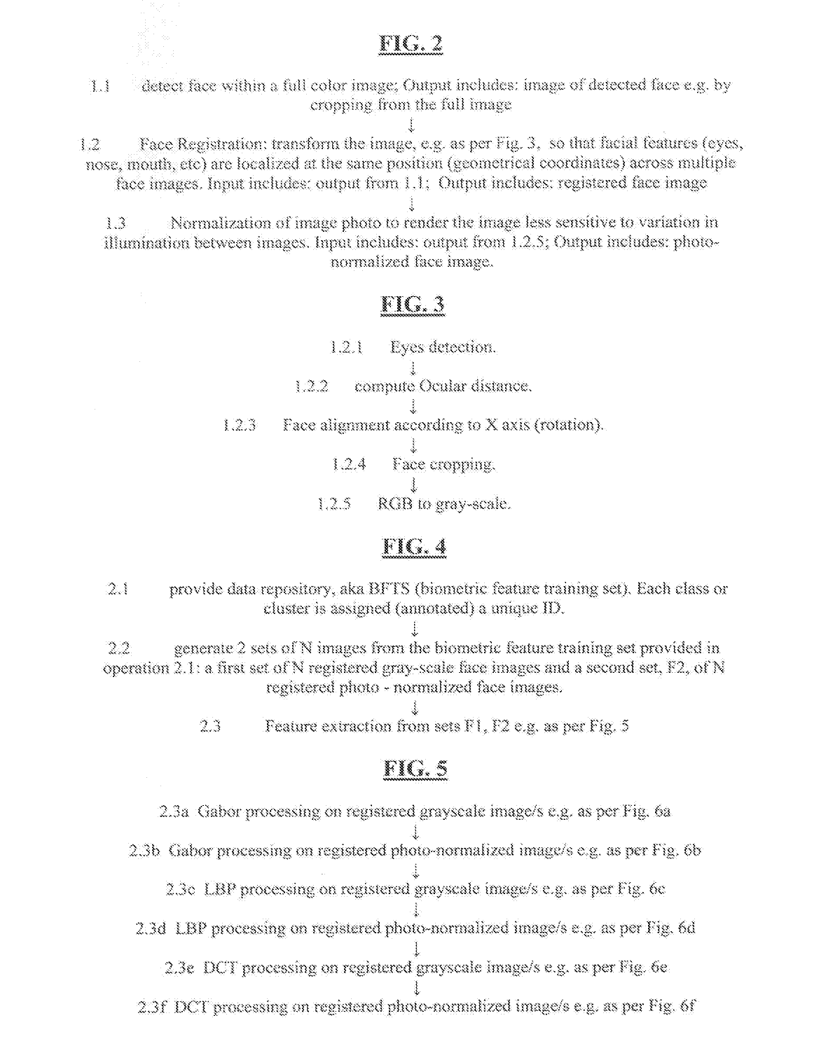

1. Image pre-processing e.g. as per FIG. 2. Input typically includes full color image. Output typically includes 1 gray-scale registered face image (output of operation 1.2.5 in FIG. 3) AND 1 photo-normalized face image (output of operation 1.3 in FIG. 2).
2. Training to form biometric features e.g. as per FIG. 4—for constructing at least one biometric feature set, including a statistical distribution thereof, from a multiplicity of N facial images; typically 6 biometric feature sets are generated.
e.g. Input a set of N (say: 100,000) images, construct feature set therefor (e.g. using at least one suitable feature extraction transformation such as but not limited to Gabor, LBP, DCT) and learn feature statistics e.g. by applying WPCA, LDA, and/or PLDA to at least one feature set, thereby to generate at least one template; Output includes: 6 Biometric Trained Models (output of operations 2.3.4, 2.3.8, 2.3 12, 2.3.16, 2.3.19, and 2.3.22, respectively).
3. Training to compute 6 individual matching scores e.g. as per FIG. 7 for generating at least one template (typically 6 such templates are generated) from a multiplicity of M facial images which is at least partly disjoint to the multiplicity of N facial images i.e. the set of M images includes at least some, and preferably a majority of, images absent from the set of N images. For example, at least 30% or at least 50% or at least 75% or at least 90% or at least 95% or at least 99% of the images in the set of M images may be images absent from the set of N images.

It is appreciated that typically, two separate at least partly disjoint sets of images (samples) are provided, one for fusion and one for training models, rather than using the same set for both purposes. Typically, the less common samples between the two sets, the smaller the resulting bias.

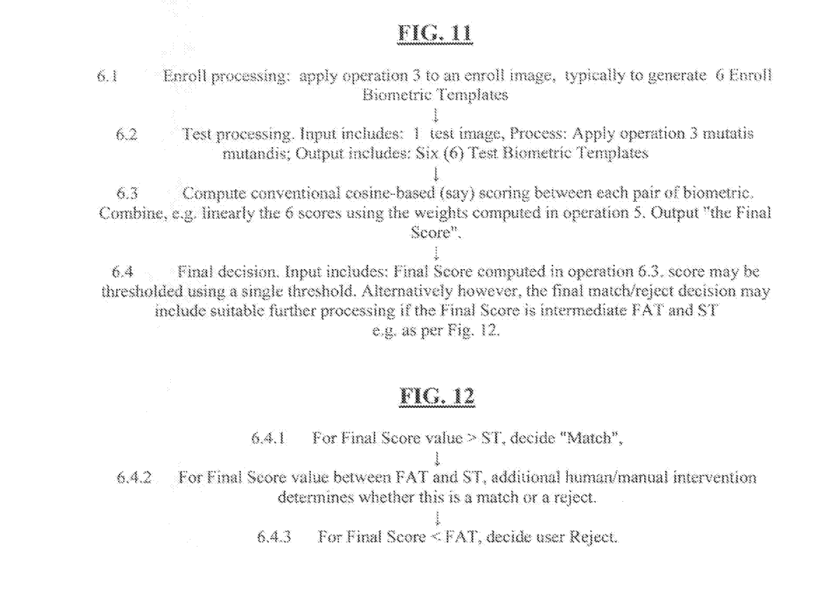

4. Compute Scores by matching (comparing) each sample against others e.g. as per FIG. 10.
5. Fusion at score level e.g. by computing an optimum weight vector, including 6 (say) weights, which may be used to linearly combine the 6 (say) scores a-f (each of which may be represented as a 6×P matrix) computed in operation 4 (e.g. in operations 4.1-4.6 respectively) into a final aggregated score. LLR fusion technique may be used to aggregate scores.
6. determine: does test image matched enrolled (“enroll”) image/s?

The method of FIG. 2 typically includes some or all of the following operations, which may be performed in any suitable order such as but not limited to the following order:

1.1 detect face within a full color image; Output includes: image of detected face e.g. by cropping from the full image
1.2 Face Registration: transform the image, e.g. as per FIG. 3, so that facial features (eyes, nose, mouth, etc) are localized at the same position (geometrical coordinates) across multiple face images. Input includes: output from 1.1; Output includes: registered face image
1.3 Normalization of image photo (e.g. using any suitable conventional contrast stretching or histogram stretching or dynamic range expansion) to render the image less sensitive to variation in illumination between images. Input includes: output from 1.2.5; Output includes: photo-normalized face image.

The method of FIG. 3 typically includes some or all of the following operations, which may be performed in any suitable order such as but not limited to the following order:

1.2.1 Eyes detection. Input includes: output from 1.1; Process: detect left eye, detect right eye; Output includes: (x,y) coordinates for the left and right eye.
1.2.2 Ocular distance. Input includes: output from 1.2.1; Process: Compute the ocular distance; Output includes: Ocular distance.
1.2.3 Face alignment according to X axis (rotation). Input includes: output from 1.1 and output from 1.2.1; Process: the face is rotated so that the difference between the y-coordinate of the left eye and y-coordinate of the right eye is zero; Output includes: X-axis aligned face image.
1.2.4 Face cropping. Input includes: output from 1.2.2 and output from 1.2.3; Process: the face is cropped according to some predefined distances computed relative to the ocular distance; next, the face cropped face is rescaled to 100×100 pixels; Output includes: registered (scaled) face image.
1.2.5 RGB to gray-scale. Input includes: output from 1.2.4. Process: color registered face image conversion to gray-scale face image; Output includes: gray-scale registered face image.

The method of FIG. 4 typically includes some or all of the following operations, which may be performed in any suitable order such as but not limited to the following order: Training to form biometric features (6 separate models)

2.1 provide data repository, aka BFTS (biometric feature training set) including a multiplicity N. e.g. tens, thousands, 10's of thousands or 100's of thousands, of “clusters” or “classes” of full color images of human subjects' faces, each cluster or class including plural e.g. several or dozens or more samples (images) of a single subject, typically acquired under various environment conditions. Each class or cluster is assigned (annotated) a unique ID.
2.2 generate 2 sets of N images from the biometric feature training set provided in operation 2.1; a first set of N registered gray-scale face images and a second set, F2, of N registered photo-normalized face images.
2.3 Feature extraction from sets F1, F2 e.g. as per FIG. 5

The method of FIG. 5 typically includes some or all of the following operations, which may be performed in any suitable order such as but not limited to the following order:

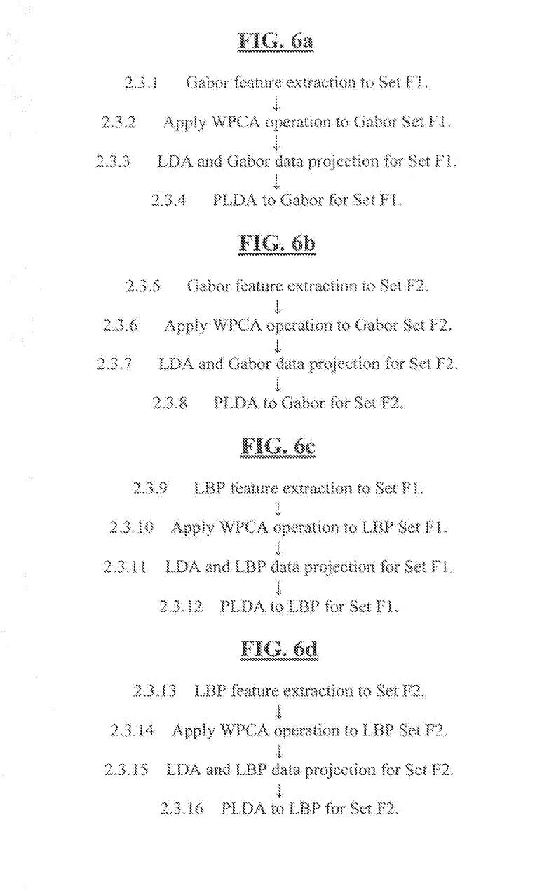

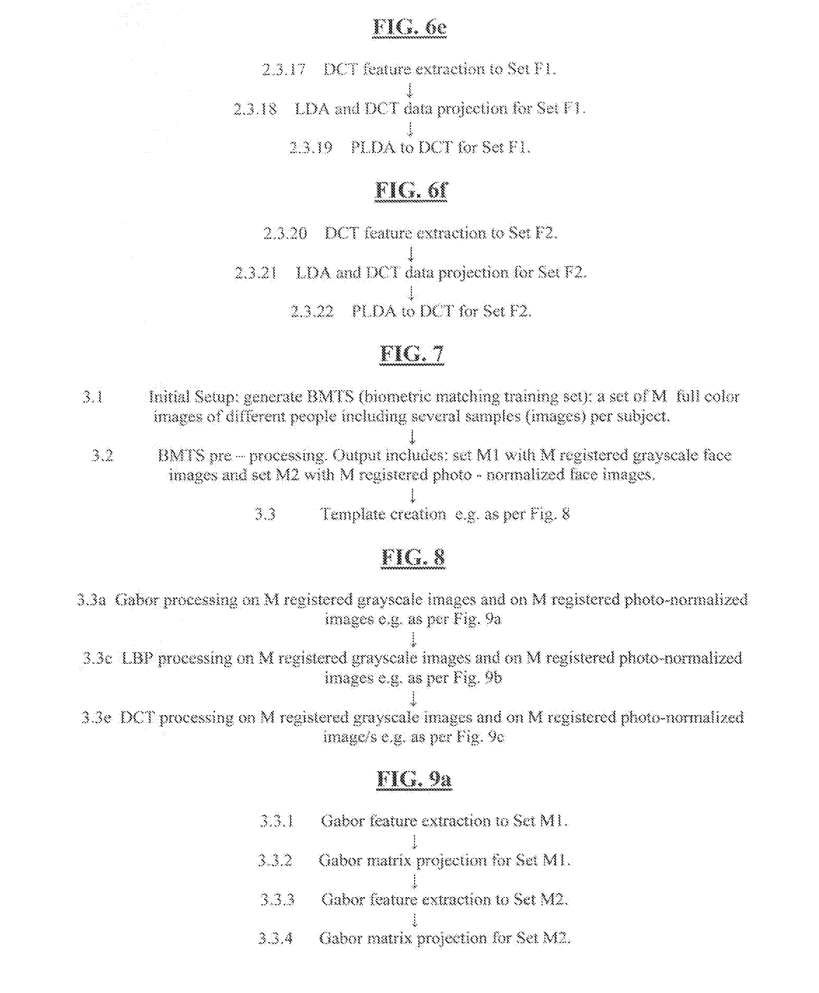

2.3a Gabor processing on registered grayscale image/s e.g. as per FIG. 6a
2.3b Gabor processing on registered photo-normalized image/s e.g. as per FIG. 6b
2.3c LBP processing on registered grayscale image/s e.g. as per FIG. 6c
2.3d LBP processing on registered photo-normalized image/s e.g. as per FIG. 6d
2.3e DCT processing on registered grayscale image/s e.g. as per FIG. 6e
2.3f DCT processing on registered photo-normalized image/s e.g. as per FIG. 6f

### FIG. 6a

The method of FIG. 6a typically includes some or all of the following operations, which may be performed in any suitable order such as but not limited to the following order: feature based extraction to each image from Set F1. Output includes: 100,000 Gabor transformation vectors corresponding to Set F collected into a Big Gabor Set F matrix.

2.3.2 Apply WPCA operation to Gabor Set F1. Input includes: output from 2.3.1; Process: Apply WPCA to reduce dimension of matrix generated in operation 2.3.1 from 100,000 to a pre-defined size. Output includes: Reduced Gabor Set F1 matrix.
2.3.3 LDA and Gabor data projection for Set F1. Input includes: output from 2.3.2; Process: Apply LDA, then project this result onto output of 2.3.2 (e.g. using matrix multiplication). Output includes: LDA Gabor Set F1 matrix.
2.3.4 PLDA to Gabor for Set F1. Input includes: output from 2.3.3; Process: Apply PLDA to that input. Output includes: Gabor type Biometric Trained Model for Set F1.

The method of FIG. 6b typically includes some or all of the following operations, which may be performed in any suitable order such as but not limited to the following order:

2.3.5 Gabor feature extraction to Set F2. Input includes: Set F2; Process: Apply Gabor feature based extraction to each image from Set F2. Output includes: 100,000 Gabor transformation vectors corresponding to Set F2 collected into a Big Gabor Set F2 matrix.
2.3.6 Apply WPCA operation to Gabor Set F2. Input includes: output from 2.3.5; Process: Apply WPCA to reduce dimension of matrix generated in operation 2.3.5 from 100,000 to a pre-defined size. Output includes: Reduced Gabor Set F2 matrix.
2.3.7 LDA and Gabor data projection for Set F2. Input includes: output from 2.3.6; Process: Apply LDA, then project this result onto output of 2.3.6 (e.g. using matrix multiplication). Output includes: LDA Gabor Set F2 matrix.
2.3.8 PLDA to Gabor for Set F2. Input includes: output from 2.3.7; Process: Apply PLDA to that input. Output includes: Gabor type Biometric Trained Model for Set F2.

The method of FIG. 6c typically includes some or all of the following operations, which may be performed in any suitable order such as but not limited to the following order:

2.3.9 LBP feature extraction to Set F1. Input includes: Set F1; Process: Apply LBP feature based extraction to each image from Set F1. Output includes: 100,000 LBP transformation vectors corresponding to Set F1 collected into a Big LBP Set F1 matrix.
2.3.10 Apply WPCA operation to LBP Set F1. Input includes: output from 2.3.9; Process: Apply WPCA to reduce dimension of matrix generated in operation 2.3.9 from 100,000 to a pre-defined size. Output includes: Reduced LBP Set F1 matrix.
2.3.11 LDA and LBP data projection for Set F1. Input includes: output from 2.3.10; Process: Apply LDA, then project this result onto output of 2.3.10 (e.g. using matrix multiplication). Output includes: LDA LBP Set F1 matrix.
2.3.12 PLDA to LBP for Set F1. Input includes: output from 2.3.11; Process: Apply PLDA to that input. Output includes: LBP type Biometric Trained Model for Set F1.

The method of FIG. 6d typically includes some or all of the following operations, which may be performed in any suitable order such as but not limited to the following order:

2.3.13 LBP feature extraction to Set F2. Input includes: Set F2; Process: Apply LBP feature based extraction to each image from Set F2. Output includes: 100,000 LBP transformation vectors corresponding to Set F2 collected into a Big LBP Set F2 matrix.
2.3.14 Apply WPCA operation to LBP Set F2. Input includes: output from 2.3.13; Process: Apply WPCA to reduce dimension of matrix generated in operation 2.3.13 from 100,000 to a pre-defined size. Output includes: Reduced LBP Set F2 matrix.
2.3.15 LDA and LBP data projection for Set F2. Input includes: output from 2.3.14; Process: Apply LDA, then project this result onto output of 2.3.14 (e.g. using matrix multiplication). Output includes: LDA LBP Set F2 matrix.
2.3.16 PLDA to LBP for Set F2. Input includes: output from 2.3.15; Process: Apply PLDA to that input. Output includes: LBP type Biometric Trained Model for Set F2.

The method of FIG. 6e typically includes some or all of the following operations, which may be performed in any suitable order such as but not limited to the following order:

2.3.17 DCT feature extraction to Set F1. Input includes: Set F1; Process: Apply DCT feature based extraction to each image from Set F1. Output includes: 100,000 DCT transformation vectors corresponding to Set F1 collected into DCT Set F1 matrix.
2.3.18 LDA and DCT data projection for Set F1. Input includes: output from 2.3.17; Process: Apply LDA, then project this result onto output of 2.3.17 (e.g. using matrix multiplication). Output includes: LDA DCT Set F1 matrix.
2.3.19 PLDA to DCT for Set F1. Input includes: output from 2.3.18; Process: Apply PLDA to that input. Output includes: DCT type Biometric Trained Model for Set F1.

The method of FIG. 6f typically includes some or all of the following operations, which may be performed in any suitable order such as but not limited to the following order:

2.3.20 DCT feature extraction to Set F2. Input includes: Set F2; Process: Apply DCT feature based extraction to each image from Set F2. Output includes: 100,000 DCT transformation vectors corresponding to Set F2 collected into a DCT Set F2 matrix.
2.3.21 LDA and DCT data projection for Set F2. Input includes: output from 2.3.20; Process: Apply LDA, then project this result onto output of 2.3.20 (e.g. using matrix multiplication). Output includes: LDA DCT Set F2 matrix.
2.3.22 PLDA to DCT for Set F2. Input includes: output from 2.3.21; Process: Apply PLDA to that input. Output includes: DCT type Biometric Trained Model for Set F2.

The method of FIG. 7 typically includes some or all of the following operations, which may be performed in any suitable order such as but not limited to the following order:

3.1 Initial Setup: generate BMTS (biometric matching training set): a set of M full color images of different people including several samples (images) per subject. Typically this set is at least partly disjoint to BFTS to avoid bias. M may be any suitable number such as 200, 500, 1000, 2000, 5000, 10,000 or more.
3.2 BMTS pre-processing. Input includes: BMTS: Process: Apply operation 1 above mutatis mutandis; Output includes: 2 sets of M images, including set M1 with M registered grayscale face images and set M2 with M registered photo-normalized face images.
3.3 Template creation e.g. as per FIG. 8 (typically each template comprises an output of WPCA, LDA, PLDA or alternative techniques)

The method of FIG. 8 typically includes some or all of the following operations, which may be performed in any suitable order such as but not limited to the following order:

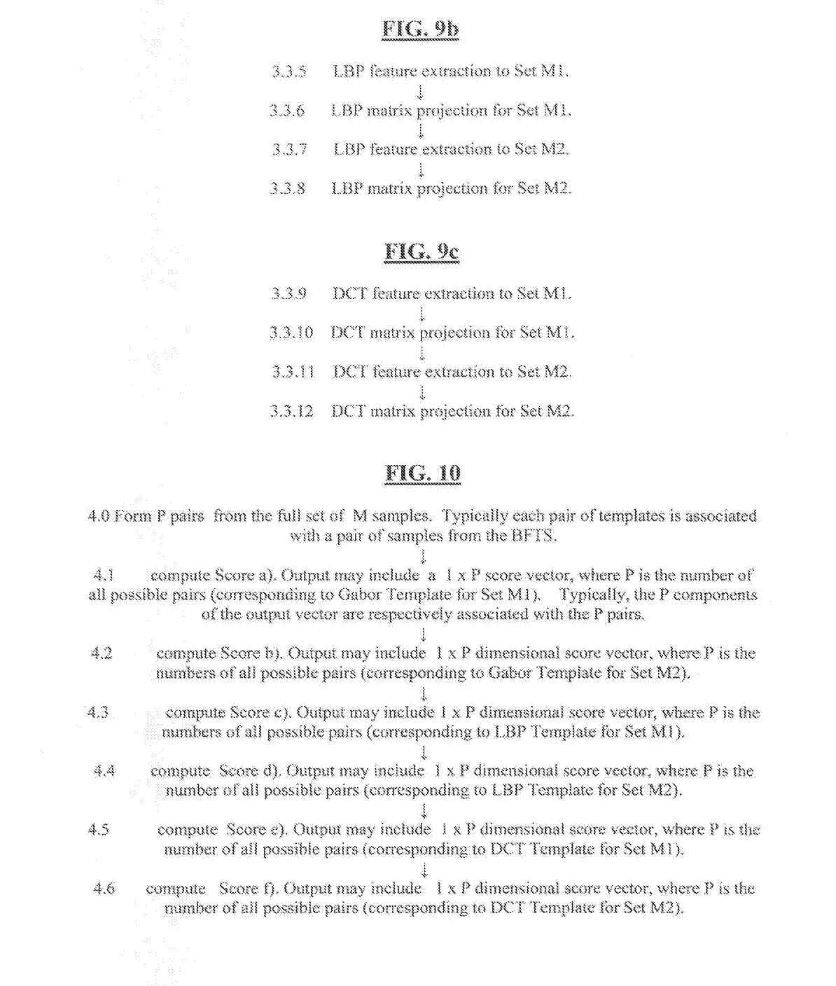

3.3a Gabor processing on M registered grayscale images and on M registered photo-normalized images e.g. as per FIG. 9a
3.3c LBP processing on M registered grayscale images and on M registered photo-normalized images e.g. as per FIG. 9b
3.3e DCT processing on M registered grayscale images and on M registered photo-normalized image/s e.g. as per FIG. 9c

The method of FIG. 9a typically includes some or all of the following operations, which may be performed in any suitable order such as but not limited to the following order:

3.3.1 Gabor feature extraction to Set M1. Input: Set M1; Process: Apply Gabor feature based extraction to each image from Set M1. Output includes: M Gabor transformation vectors corresponding to Set M1 collected into a Gabor Set M1 matrix.
3.3.2 Gabor matrix projection for Set M1. Input includes: output from 3.3.1 AND output of 2.3.4; Process: Project output of 3.3.1 into output of 2.3.4, Output includes: 1×M Gabor type Biometric Templates for Set M1.
3.3.3 Gabor feature extraction to Set M2. Input includes: Set M2; Process: Apply Gabor feature based extraction to each image from Set M2. Output includes: M Gabor transformation vectors corresponding to Set M2 collected into a Gabor Set M2 matrix.
3.3.4 Gabor matrix projection for Set M2. Input includes: output from 3.3.3 AND output of 2.3.8; Process: Project output of 3.3.3 into output of 2.3.8, Output includes: 1×M Gabor type Biometric Templates for Set M2.

The method of FIG. 9b typically includes some or all of the following operations, which may be performed in any suitable order such as but not limited to the following order:

3.3.5 LBP feature extraction to Set M1. Input includes: Set M1; Process: Apply LBP feature based extraction to each image from Set M1. Output includes: M LBP transformation vectors corresponding to Set M1 collected into a LBP Set M1 matrix.
3.3.6 LBP matrix projection for Set M1. Input includes: output from 3.3.5 AND output of 2.3.12; Process: Project output of 3.3.5 into output of 2.3.12, Output includes: 1×M LBP type Biometric Templates for Set M1.
3.3.7 LBP feature extraction to Set M2. Input includes: Set M2; Process: Apply LBP feature based extraction to each image from Set M2. Output includes: M LBP transformation vectors corresponding to Set M2 collected into a LBP Set M2 matrix.
3.3.8 LBP matrix projection for Set M2. Input includes: output from 3.3.7 AND output of 2.3.16; Process: Project output of 3.3.7 into output of 2.3.16, Output includes: 1×M LBP type Biometric Templates for Set M2.

The method of FIG. 9c typically includes some or all of the following operations, which may be performed in any suitable order such as but not limited to the following order:

3.3.9 DCT feature extraction to Set M1. Input includes: Set M1; Process: Apply DCT feature based extraction to each image from Set M1. Output includes: M LBP transformation vectors corresponding to Set M1 collected into a DCT Set M matrix.
3.3.10 DCT matrix projection for Set M1. Input includes: output from 3.3.9 AND output of 2.3.19; Process: Project output of 3.3.9 into output of 2.3.19, Output includes: 1×M DCT type Biometric Templates for Set M1.
3.3.11 DCT feature extraction to Set M2. Input includes: Set M2; Process: Apply DCT feature based extraction to each image from Set M2. Output includes: M LBP transformation vectors corresponding to Set M2 collected into a LBP Set M2 matrix.
3.3.12 DCT matrix projection for Set M2. Input includes: output from 3.3.11 AND output of 2.3.22; Process: Project output of 3.3.11 into output of 2.3.22, Output includes: 1×M DCT type Biometric Templates for Set M2.

The method of FIG. 10 typically includes some or all of the following operations, which may be performed in any suitable order such as but not limited to the following order:

4.0 Form P pairs from the full set of M samples. For example, if M is 1598, P may be=2,553,606 or M squared. Typically P=CONTC+CONTI, where CONTC is the number of each pair satisfying CLASS_ID(i)=CLASS_ID(j) (i.e. if the samples i and j from the pair (i,j) belong to the same class) and CONTC is the number of each pair satisfying CLASS_ID(i)≠CLASS_ID(j) (sample i and i belongs to different classes), for any i=1, . . . , M and any j=1, . . . M. Typically each pair of templates is associated with a pair of samples from the BFTS. According to certain embodiments, the number of templates equals the number of samples.
4.1 compute Score a). Input includes: Pairs of biometrics templates formed in operation 4.0, to which operation 3.3.2 was applied; Process: Compute conventional cosine-based scoring between pairs; Output may include a 1×P score vector, where P is the number of all possible pairs (corresponding to Gabor Template for Set M1). Typically, the P components of the output vector are respectively associated with the P pairs.
4.2 compute Score b). Input includes: Pairs of biometrics templates formed in operation 4.0, to which operation 3.3.4 was applied; Process: Compute conventional cosine-based scoring between pairs; Output includes: 1×P dimensional score vector, where P is the numbers of all possible pairs (corresponding to Gabor Template for Set M2).
4.3 compute Score c). Input includes: Pairs of biometric templates formed in operation 4.0, to which operation 3.3.6 was applied; Process: Compute conventional cosine-based scoring between pairs; Output includes: 1×P dimensional score vector, where P is the numbers of all possible pairs (corresponding to LBP Template for Set M1).
4.4 compute Score d). Input includes: Pairs of biometric templates formed in operation 4.0, to which operation 3.3.8 was applied; Process: Compute conventional cosine-based scoring between pairs; Output includes: 1×P dimensional score vector, where P is the number of all possible pairs (corresponding to LBP Template for Set M2).
4.5 compute Score e). Input includes: Pairs of biometric templates formed in operation 4.0, to which operation 3.3.10 was applied; Process: Compute conventional cosine-based scoring between pairs; Output includes: 1×P dimensional score vector, where P is the number of all possible pairs (corresponding to DCT Template for Set M1).
4.6 compute Score f). Input includes: Pairs of biometrics templates formed in operation 4.0, to which operation 3.3.12 was applied; Process: Compute conventional cosine-based scoring between pairs; Output includes: 1×P dimensional score vector, where P is the number of all possible pairs (corresponding to DCT Template for Set M2).

The method of FIG. 11 typically includes some or all of the following operations, which may be performed in any suitable order such as but not limited to the following order:

6.1 Enroll processing: apply operation 3 to an enroll image, typically to generate 6 Enroll Biometric Templates (outputs of applying operations 3.3.2, 3.3.4, 3.3.6, 3.3.8, 3.3.10, and 3.3.12 respectively)
6.2 Test processing. Input includes: 1 test image, Process: Apply operation 3 mutatis mutandis; Output includes: Six (6) Test Biometric Templates (output of 3.3.2, 3.3.4, 3.3.6, 3.3.8, 3.3.10, and 3.3.12)
6.3 Score and match. Input 6 enroll Biometric Templates and 6 Test Biometric Templates thereby to define 6 pairs of templates. Compute conventional cosine-based scoring between each pair of biometric. linearly combine the 6 scores using the weights computed in operation 5. Output includes: Single Score Value also termed “the Final Score”.
6.4 Final decision. Input includes: Final Score computed in operation 6.3. score may be thresholded using a single threshold such that scores above the single threshold indicate that the test and enroll images match whereas the test image is rejected as dissimilar to the enroll image if the final score generated in operation 6.3 falls below the single threshold. Alternatively however, 2 thresholds, FAT and ST are predefined: the final match/reject decision may then include suitable further processing if the Final Score is intermediate FAT and ST e.g. as per FIG. 12.

The method of FIG. 12 typically includes some or all of the following operations, which may be performed in any suitable order such as but not limited to the following order:

6.4.1 For Final Score value >ST, decide “Match”,
6.4.2 For Final Score value between FAT and ST, additional human/manual intervention determines whether this is a match or a reject. e.g. user picks a “correct” pictogram from among several presented to her or him; password recognition; voice recognition, etc.
6.4.3 For Final Score <FAT, decide user Reject.

It is appreciated that the particular operations in FIGS. 1-12, or any suitable subset thereof, may be provided and performed in any suitable order such that the particular methods of FIGS. 1-12 are not intended to be limiting.

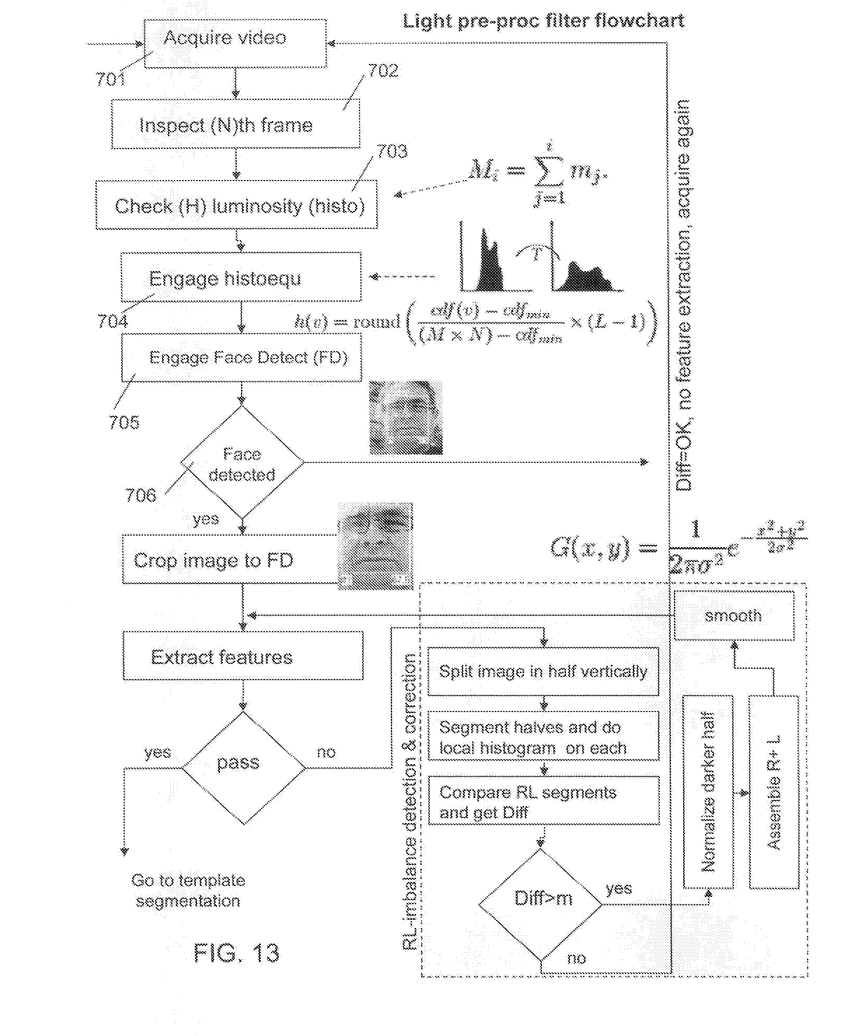

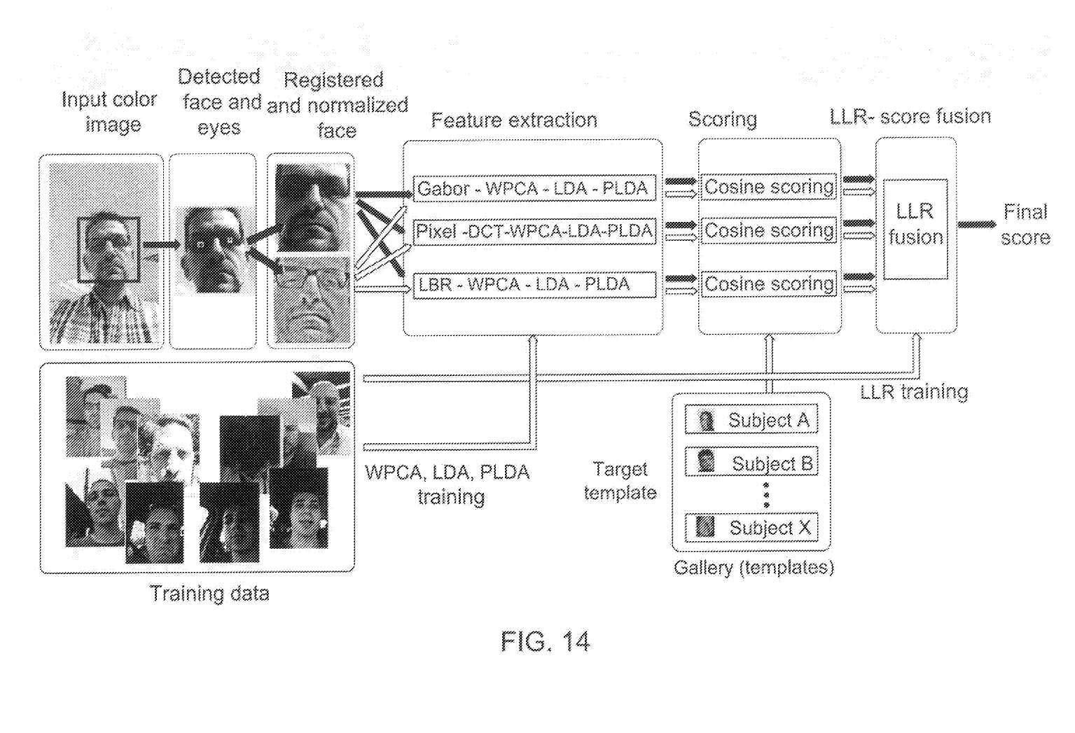

Referring now to FIG. 13, the term “global histogram equalization” is intended to include contrast adjustment using image's histogram. A light pre-process may include an operation 701 of acquiring the video (or the image), operation 702 of inspect N(th) frame of the video, operation 703 checks the luminosity histogram, and then performs global histogram equalization in operation 704. At this point the picture undergoes face detection (operation 705), e.g. using any method described herein, in case of a failure of face detection the entire process starts again.

The application, in its different manifestations, may use Face Recognition to authenticate a smartphone's user as its legitimate owner and allow/deny access to the phone itself (phone unlock) and/or to specific applications as defined by the user.

The application may perform some or all of:

1. Enrollment

2. Setup & Application Assignment

3. User authentication: Face capture

4. User authentication: Successful analysis and positive authentication of user

5. User authentication: Successful analysis and negative authentication of user

6. Failure: either face capture or analysis fail

At Startup by default: By default, once the application is installed, enrolled, provisioned and enabled the application may require no launch since it works in the background constantly monitoring the applications it is assigned to protect. If such application is launched by the user, the application may sense that and automatically launch the notification avatar which may act to authenticate the user while working concurrently with the application launched, thus the workflow does not stop to authenticate the user; authentication is handled in parallel with the normal workflow. The notification avatar can be disabled e.g. from a setup panel of the Athena application.

The application may be enabled or disabled (as master switch) by the application setup. If disabled, it may provide protection to no application. If enabled, all protection logic is available for selected applications, users and phone.

In one example, a smartphone user installed the application. On operating the smartphone, the application detects the face of the user and performs global histogram equalization and then face recognition. If the face recognition is successful (that is, the person operating the phone is the registered user), the smartphone may be activated; in cases where the detection fails, the smartphone may be locked.

In another example, a tablet user installed the application. The application is running while the tablet is working, and only when trying to access a predefined second application in the tablet, does the recognition application alert on failing/succeeding in the face recognition.

The particular description herein is not intended to be limiting. Any suitable implementation of FIG. 1 or indeed of FIG. 13 or 14 may be employed, separately or in any suitable combination. For example, WPCA, LDA, PLDA are merely examples of dimensionality reduction methods e.g. of computational transformations which, when applied to face recognition data, convert the face recognition data from one space to another e.g. from a high dimensional space poorly suited for a particular use-case such as a real-time authentication task, to a lower dimensional space more suited for that use-case. Also, Gabor features, LBP features and pixel-intensity features are merely examples of useful features and others may be extracted alternatively or in addition. Also, the specific templates described herein are not intended to be limiting, alternatively, any suitable output of a projection of one feature vector into a biometric trained model may be employed as a template.

According to certain embodiments of facial authentication, plural feature extraction technologies (which may include some or all of Gabor, LBP, DCT) are applied to raw images of faces, directly or after pre-processing thereof, and plural similarity scores are generated respectively by comparing resulting features from images of faces to be compared; then a final similarity determination is made including combining (using any suitable combination technique known in the art) the plural scores into a single final score.

According to certain embodiments, plural pre-processing technologies are employed to generate images (e.g. to generate both gray-scale registered images and registered photo-normalized images from raw images of faces) to which to apply one or more feature extraction technology, and plural similarity scores are generated by comparing resulting features; then a final similarity determination is made including combining (using any suitable combination technique known in the art) the plural scores into a single final score.

According to certain embodiments, plural (e.g. K) feature extraction technologies are crossed with plural (e.g. L) pre-processing technologies and plural (K×L) similarity scores are generated by comparing resulting features; then a final similarity determination is made including combining (using any suitable combination technique known in the art) the plural scores into a single final score.

Any or all of the operations of any or all of the following methods A-E may for example be performed, together or separately; operations within methods A-E may also be suitably combined with the methods of FIGS. 1-12:

Face Recognition—Method A

100: setup: training (e.g. by performing method B)

110: Acquire “target” color images from each of a population of registered users; store in “enroll data set” repository in association with unique identifier for each user

115: generate 6-feature “compact biometric feature data set” for each target image (e.g. by performing method c) and, typically, store in the “enroll data set” repository for subsequent uses e.g. in operation 120

120: matching attempt—does a specific query image match a specific target image? (e.g. by performing method c). if query image is an unknown user, flowchart c may be performed 100,000 times (say) to compare the query image's data set to each of the 100,000 (say) data sets in the “enroll data set” repository

Training—Method b

210: Assemble, from repositories such as Facebook, plural images of each of a multiplicity of human subjects with representation for various illumination conditions and presence/absence of various common occlusions

220: In computer storage, annotate images to indicate which images are associated with a single subject

230: Train on the annotated images, thereby to generate 3×2=6 PCA transformation matrices, 6 LDA transformation matrices and 6 PLDA transformation matrices to be used, in operation 470, for extraction of each of Gabor features, LBP features and pixel-intensity features, from each of 1^{st} and 2^{nd} gray-scale representations of a current image

240: Use PCA (Principal Component Analysis)-based whitening transform (WPCA) to reduce data dimensionality.

250: Apply WPCA to the Gabor and LBP transformations to reduce memory footprint

260: Linear discriminant analysis (LDA) projection

270: Compute PLDA (Probabilistic Linear Discriminant Analysis) feature vectors for each of the two image descriptors employed in the LBP transformation.

Matching—Method c

305—Generate “compact biometric feature data set” for 1^{st} & 2^{nd} gray-scale representations of the query image (e.g. by performing method d)

315—Compute 6 cosine-based scores by respectively comparing each of the 6 features of the target image's feature data set with each of the 6 features of the target image

325—Use linear-logistic-regression-based (LLR) fusion to combine the 6 cosine-based scores into a final target-query similarity score for a given matching attempt

335—Output genuine/imposter if final similarity score is above/below predetermined threshold

Feature Extraction—Method d:

420: Detect face/s e.g. using Viola-Jones object detector trained on faces

430: If no face detected and light is low, repeat face detection with low-light compensation

440: Crop largest face

450: Registration of face thereby to generate 1st gray-scale image (e.g. by performing method e)

460: Generate 2nd gray-scale image using photo-normalization procedure

470: Extract facial Features: use the PCA, LDA and PLDA transformation matrices generated in training operation 100, to extract each of Gabor features, LBP features and pixel-intensity features, respectively, from each of 1^{st} and 2^{nd} gray-scale images, thereby to generate, per face, a “compact biometric feature data set” including 6 sets of facial features

Face Registration—Method e

610: Detect eyes e.g. using Viola-Jones object detector trained on eyes

620: Find ocular distance

630: Determine left/right/up/down crop parameters by computing predetermined percentages of ocular distance

640: Crop face relative to left eye coordinates, using crop parameters

650: Rescale face to predetermined uniform size (x pixels times y pixels)

660: output 1^{st} gray scale image

A enroll (gallery) biometric template may be generated including projecting the enroll biometric data features into trained models by multiplying the matrix associated with the biometric template with the matrix associated with the trained model.

It is appreciated that parameters and values stipulated herein are merely by way of example.

Mobile devices may be biometrically enabled using certain embodiments herein, and/or biometric apps, implementing certain embodiments herein, may be downloaded.

Advantages of certain embodiments include:
a. low false reject levels i.e. failure to recognize registered users is infrequent even given challenges hampering face recognition such as bright sunshine, dark rooms, and shadows on the user's face.
b. set-up e.g. training the face authentication system to recognize an end user's face requires that end use only to take 2-3 unsupervised selfies, typically in any conditions.
c. Since a mobile device protected with the face recognition system herein is uniquely personal, enterprise management is facilitated e.g. in terms of employee management such as but not limited to Time & Attendance fraud prevention e.g. “buddy punching”, allowing remote employees to clock in and out, obviating the need for an on-site attendance clock, and management of restricted data access and restricted work areas.
d. privacy may be enhanced by storing digital data e.g. templates representing registered users' faces, rather than the faces themselves.
e. yields an electronic verification tool accurate enough for secure online and mobile operations including but not limited to banking and communication, including but not limited to email and social networking.
f. fast enough and accurate enough to be useable for real-time mobile applications having limited hardware capabilities and resources, as compared to PC server based applications.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required, or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may if desired be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to ooptical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. A method for recognizing faces including:
providing at least one image in which a face is to be recognized;
using a processor for constructing at least one biometric feature set, including a statistical distribution thereof, from a multiplicity of N facial images (samples);
generating at least one template, using a processor, from a multiplicity of M facial images which is at least partly disjoint to the multiplicity of N facial images;
computing scores, using a processor, to quantify an extent to which at least some of said templates match one another, pairwise; and
testing whether an enroll image and a test image match by using plural feature extraction technologies to generate plural respective templates for the enroll image and plural respective templates for the test image and comparing said plural templates for the enroll image to said plural templates for the test image thereby to generate at least one score indicating an extent to which the enroll and test images match.

2. A method according to claim 1 wherein WPCA is used to construct at least one biometric feature set from the multiplicity of N facial images.

3. A method according to claim 1 wherein LDA is used to construct at least one biometric feature set from the multiplicity of N facial images.

4. A method according to claim 1 wherein PLDA is used to construct at least one biometric feature set from the multiplicity of N facial images.

5. A method according to claim 1 wherein at least one biometric feature set is constructed from a multiplicity of N gray-scale registered images each generated from a raw color image.

6. A method according to claim 1 wherein at least one biometric feature set is constructed from a multiplicity of N registered photo-normalized images each generated from a raw color image.

7. A face recognition system including:
a repository including at least one biometric feature set, including a statistical distribution thereof, constructed from a multiplicity of N facial images (samples); and
a processor configured for generating at least one template from a multiplicity of M facial images which is at least partly disjoint to the multiplicity of N facial images, computing scores to quantify an extent to which at least some of said templates match one another, pairwise; and testing whether an enroll image and a test image match by using plural feature extraction technologies to generate plural respective templates for the enroll image and plural respective templates for the test image and comparing said plural templates for the enroll image to said plural templates for the test image thereby to generate at least one score indicating an extent to which the enroll and test images match.

8. A method according to claim 5 or claim 6 wherein said raw color image is imaged by a mobile device camera.

9. A method according to claim 1 wherein said at least one biometric feature set comprises first and second biometric feature sets respectively constructed from a first multiplicity of N gray-scale registered images and a second multiplicity of N registered photo-normalized images and wherein corresponding pairs of first and second images, from among the first and second multiplicities respectively, are both generated from the same raw color image in a data repository including N raw color images.

10. A method according to claim 1 wherein WPCA is used to generate at least one template from the multiplicity of M facial images.

11. A method according to claim 1 wherein LDA is used to generate at least one template from the multiplicity of M facial images.

12. A method according to claim 1 wherein PLDA is used to generate at least one template from the multiplicity of M facial images.

13. A method according to claim 1 wherein at least one biometric feature set is generated from a multiplicity of M grayscale registered images each generated from a raw color image.

14. A method according to claim 1 wherein at least one biometric feature set is generated from a multiplicity of M registered photo-normalized images each generated from a raw color image.

15. A method according to claim 13 or 14 wherein said raw color image is imaged by a mobile device camera.

16. A method according to claim 1 wherein said at least one biometric feature set comprises first and second biometric feature sets respectively constructed from a first multiplicity of M gray-scale registered images and a second multiplicity of M registered photo-normalized images and wherein corresponding pairs of first and second images, from among the first and second multiplicities respectively, are both generated from the same raw color image in a data repository including M raw color images.

17. A method according to claim 1 wherein said computing of scores employs cosine-based scoring.

18. A method according to claim 1 wherein said templates include templates derived using plural feature extraction technologies and wherein said computing scores comprises fusing scores quantifying an extent to which templates derived using a first feature extraction technology match pairwise with scores quantifying an extent to which templates derived using at least a second feature extraction technology match pairwise.

19. A method according to claim 1 wherein said templates include templates derived from grayscale registered images and templates derived from registered photo-normalized images and wherein said computing scores comprises fusing scores quantifying an extent to which templates derived from gray-scale registered images match pairwise with scores quantifying an extent to which templates derived from registered photo-normalized images match pairwise.

20. A method according to claim 1 wherein said plural feature extraction technologies include at least one of: Gabor, LBP, DCT.

21. A method according to claim 19 wherein said fusing comprises computing a linear combination of scores.

22. A method according to claim 19 wherein said fusing comprises LLR fusion.

23. A method according to claim 1 wherein said testing includes generating gray-scale registered and registered photo-normalized images from a full color raw enroll image, generating gray-scale registered and registered photo-normalized images from a full color raw test image, and applying plural feature extraction technologies to the gray-scale registered and registered photo-normalized images generated from the full color raw enroll image and also to the gray-scale registered and registered photo-normalized images generated from the full color raw test image.

24. A method according to claim 1 and also comprising thresholding said score using at least first and second thresholds and determining whether the enroll and test images do or do not match, if the score outlies the first and second thresholds respectively and performing at least one additional identity verification process if the score lies between the first and second thresholds.

25. A computer program product, comprising a non-transitory tangible computer readable medium having computer readable program code embodied therein, said computer readable program code adapted to be executed to implement a method for recognizing faces including:
providing at least one image in which a face is to be recognized;
constructing at least one biometric feature set, including a statistical distribution thereof, from a multiplicity of N facial images (samples);
generating at least one template from a multiplicity of M facial images which is at least partly disjoint to the multiplicity of N facial images;
computing scores to quantify an extent to which at least some of said templates match one another, pairwise; and
testing whether an enroll image and a test image match by using plural feature extraction technologies to generate plural respective templates for the enroll image and plural respective templates for the test image and comparing said plural templates for the enroll image to said plural templates for the test image thereby to generate at least one score indicating an extent to which the enroll and test images match.
